(19) United States
(12) Patent Application Publication
(10) Pub. No.: US 2022/0127161 A1
(43) Pub. Date: Apr. 28, 2022

(54) LIQUID PURIFIER

(71) Applicant: LG ELECTRONICS INC., Seoul (KR)

(72) Inventors: Jingyu JI, Seoul (KR); Munjae JANG, Seoul (KR)

(73) Assignee: LG ELECTRONICS INC.

(21) Appl. No.: 17/509,345

(22) Filed: Oct. 25, 2021

(30) Foreign Application Priority Data
Oct. 26, 2020 (KR) 10-2020-0139349

(51) Int. Cl. C02F 1/00

(52) U.S. Cl. CPC C02F 1/003; C02F 2201/004; C02F 2201/005; C02F 2307/10

(57) ABSTRACT

A purifier includes a housing, a filter, a supply flow path supplying water from a source to the filter, a supply valve on the supply flow path to regulate flow through the supply flow path, a nozzle provided outside of the housing, a purified liquid flow path to guide liquid from the filter toward the nozzle, a hot liquid flow path having one side branched from the purified liquid flow path and another side connected to the nozzle, a hot water module provided to heat liquid in the hot liquid flow path, a sterilization flow path having one side branched from the supply flow path and another side connected to the filter, a sterilization valve provided on the sterilization flow path to regulate flow through the sterilization flow path, and a sterilization module provided on the sterilization flow path to heat liquid in the sterilization flow path.

### CROSS-REFERENCE TO RELATED APPLICATION

The present application claims priority under 35 U.S.C. 119 and 35 U.S.C. 365 to Korean Patent Application No. 10-2020-0139349, filed in Korea on Oct. 26, 2020, which is hereby incorporated by reference in its entirety.

### BACKGROUND

### 1. Field

In general, a water purifier (or liquid purifier) is a device that filters water or other liquid to remove impurities and is widely used for home use.

### 2. Background

In detail, the water purifier is connected to the water supply to remove floating substances, harmful components, or the like contained in the tap water using a filter and is configured to purify as much water as desired according to the user's manipulation and to take out the purified water. Such water purifiers are released in a variety of products capable of taking out hot and cold water as well as purified water. In addition, in recent years, a water purifier that is small in size and can be installed in various installation environments has been developed.

In addition, a pipe for flowing purified water is provided inside the water purifier, and a valve, a water-intake port, and the like are provided in the pipe. In a case where the water purifier is used for a long time, foreign substances contained in the water may be caught in pipes, valves, water-intake ports, or the like, and microorganisms or the like may be propagated therein. However, in the prior art, in order to wash the flow path or the like of the water purifier, there is a problem that the cover must be separated from the main body of the water purifier and various pipes exposed to the outside must be connected to a separate washing device.

According to Korean Patent Publication No. 10-2001-0111954, a water purifier is provided which is installed in the order of a precipitation filter, a free carbon filter, a membrane filter, and a post carbon filter and includes a purified water flow path and a take-out nozzle. In the water purifier of the prior art as described above, purified water passing through the filter is directly supplied to the water take-out nozzle along the purified water flow path.

In addition, in a case of a water purifier having a cold water function, the purified water passing through the filter is cooled while passing through the cold water module and then may be supplied to the water take-out nozzle along the cold water flow path. In addition, in a case of a water purifier having a hot water function, the purified water passing through the filter is heated while passing through the hot water tank and then supplied to the water take-out nozzle along the hot water flow path.

As described above, the purified water taken out from the filter passes through several flow paths, valves, tanks, and the like until being taken out through the water take-out nozzle. In this case, in a case where the water purifier is used for a long time, foreign substances contained in the water may be caught in pipes, valves, and the like, and microorganisms or the like may be propagated therein.

Therefore, it is necessary to periodically sterilize the flow path, the valve, and the like. In the case of the prior art, since the sterilization process of the flow paths, valves, and the like is complicated, most of the professional coordinators who have received separate training visit and sterilize the flow paths, valves, and the like of the water purifier. Therefore, even if the user recognizes the need to sterilize the flow paths, valves, and the like of the water purifier, the water purifier cannot be sterilized at a desired time, and the maintenance and management cost of the water purifier is inevitably increased due to the visit care of a professional coordinator.

In addition, in the case of the prior art, it is necessary to provide a separate sterilization kit for sterilizing the flow paths, valves, and the like of the water purifier. In this case, there is a problem in that the cost is added to provide the sterilization kit, and the difficulty of the sterilization operation through the sterilization kit is high, so that it is difficult for the user to directly proceed with the sterilization.

In addition, in the case of the prior art, it was impossible to sterilize the flow paths, the valves, and the like through which the water passing through the filter device passes until it is supplied to the water take-out nozzle. Therefore, there is a problem that is not hygienic.

In addition, in the case of the prior art, the manager periodically visits once every few months to wash the water flow path in the water purifier in a face-to-face manner, but recently, with the increase of single-person households and preference for non-face-to-face methods, a method in which the user directly manages the water purifier is required. In the case of the existing ‘self-managed’ water purifier, the flow path after the filter is washed with electrolyzed water, but this has limitations in that it is impossible to wash the filter and to remove bacteria attached to the flow path.

### BRIEF DESCRIPTION OF THE DRAWINGS

Embodiments will be described in detail with reference to the following drawings in which like reference numerals refer to like elements, and wherein:

FIG. 1 is a perspective view illustrating a water purifier according to an embodiment of the present disclosure;

FIG. 2 is an exploded perspective view illustrating a water purifier according to an embodiment of the present disclosure;

FIG. 3 is a perspective view illustrating a water take-out module, which is a component of the present disclosure;

FIG. 4 is a view illustrating flow paths and valves in the water purifier of the present disclosure;

FIG. 5 is a block diagram illustrating a water purifier according to an embodiment of the present disclosure; and

FIG. 6 is a flowchart illustrating a method for controlling a water purifier according to an embodiment of the present disclosure.

### DETAILED DESCRIPTION

Hereinafter, some embodiments of the present disclosure will be described in detail with reference to exemplary drawings. In adding reference numerals to components in each drawing, it should be noted that the same components are given the same reference numerals as much as possible even though they are indicated in different drawings. In addition, in describing the embodiment of the present disclosure, if it is determined that a detailed description of a related known configuration or function interferes with the understanding of the embodiment of the present disclosure, the detailed description thereof will be omitted.

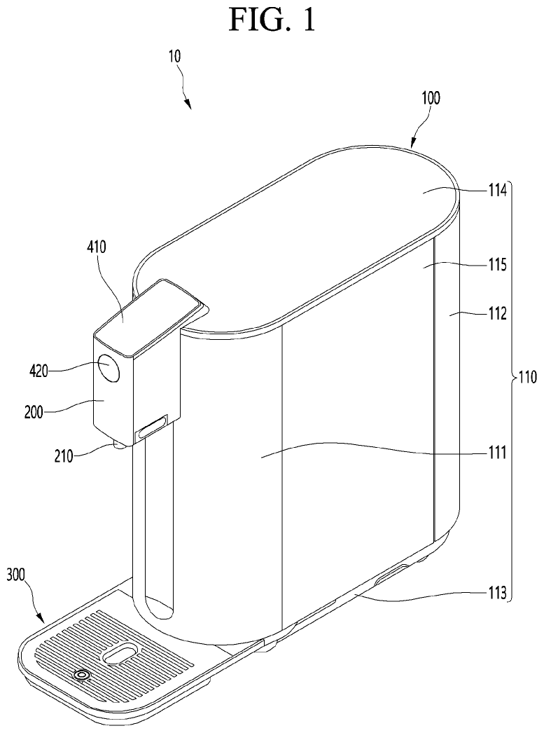

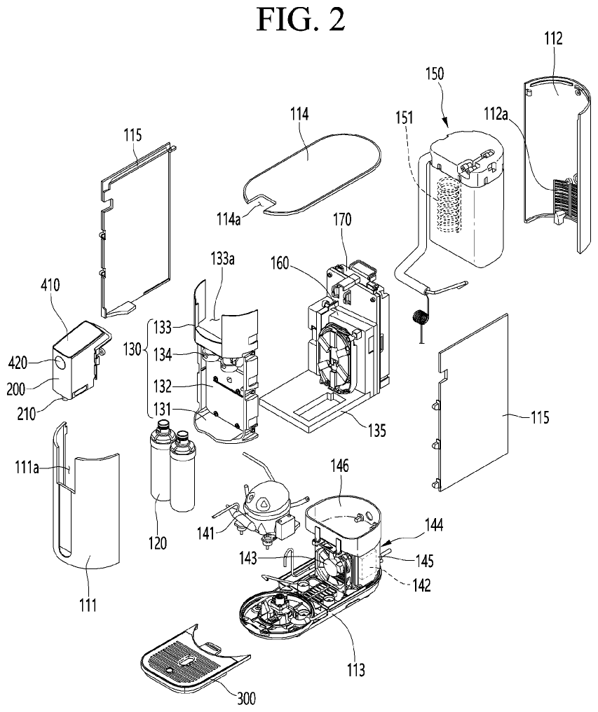

FIG. 1 is a perspective view illustrating a water purifier according to an embodiment of the present disclosure, and FIG. 2 is an exploded perspective view illustrating the water purifier. Referring to FIGS. 1 and 2, the water purifier 10 according to an embodiment of the present disclosure may include a housing 110 which forms a storage space and forms an outer shape of the water purifier, a water purifier main body 100 which is provided inside the housing 110 and includes a filter 120 for filtering raw water flowing from the outside, a water take-out module 200 in which a water take-out nozzle (or nozzle) 210 is provided which is formed to protrude forward of the water purifier main body 100 and supplies the water passing through the filter 120 to the outside of the water purifier main body 100, and a tray 300 provided below the water take-out nozzle 210.

First, the outer shape of the water purifier main body 100 may be formed by the housing 110. The housing 110 may be composed of a front cover 111 forming a front outer appearance thereof, a rear cover 112 forming a rear outer appearance thereof, a base 113 forming a lower surface thereof, a top cover 114 forming an upper surface thereof, and side panels 115 forming both side surfaces in the left and right direction. The front cover 111 and the rear cover 112, the base 113 and the top cover 114, and a pair of side panels 115 are assembled with each other to configure a housing 110 that forms the outer appearance of the water purifier main body 100.

At this time, the front and rear ends of the base 113 and the top cover 114 may be formed to be rounded, and the front cover 111 and the rear cover 112 may be formed to be convex forward and backward, respectively, to have a curvature corresponding to the front and rear ends of the base 113 and the top cover 114 which are formed to be rounded.

In addition, a water take-out nozzle 210 is formed on the front surface of the water purifier main body 100. In addition, the water take-out nozzle 210 may be formed to protrude downward of the water take-out module 200 formed to protrude forward of the front cover 111. Accordingly, purified water may be taken out through the water take-out nozzle 210.

To this end, mounting grooves 111a and 114a may be formed in the front cover 111 and the top cover 114, respectively, so that the water take-out module 200 can be inserted thereinto and fixed thereto. In detail, the mounting groove 111a of the front cover 111 has a shape concave downward from the upper end of the center of the front cover 111, and the mounting groove 114a of the top cover 114 has a concave shape from the tip to the rear of the top cover 114.

A filter 120 for water purification and a filter bracket 130 to which a plurality of valves (not illustrated) are mounted are provided inside the housing 110. The filter bracket 130 may be composed of a bottom part 131 coupled to the base 113, a filter receiving part 132 in which the filter 120 is received, and a water take-out module mounting part 133 in which the water take-out module 200 is mounted.

In detail, the bottom part 131 is formed to correspond to the shape of the front end of the base 113 and is coupled to the base 113. The mounting position of the filter bracket 130 may be fixed by the coupling of the bottom part 131, and the shape of the bottom surface of the filter receiving part 132 may be formed. The filter bracket 130 may be caught and constrained to the base 113 by a hook method and may also be fixed by a screw fastened to the lower surface of the base 113.

The filter receiving part 132 is formed to extend in the vertical direction and forms a recessed space from the front (left in the drawing) to the rear (right in the drawing) so that the filter 120 can be received. A plurality of filters 120 may be mounted on the filter receiving part 130. The filter 120 is for purification of supplied raw water (tap water) and may be configured to combine filters having various functions.

In addition, a filter socket 134 to which the filter 120 is mounted may be further provided in the filter receiving part 130, a pipe through which purified water flows is provided in the filter socket 134, and the pipe may be connected to a plurality of valves (not illustrated). Accordingly, the raw water passes through the filter 120 in turn and then can be directed to a valve (not illustrated) for water supply.

A plurality of valves (not illustrated) may be provided on the rear surface (right side of the drawing) of the filter receiving part 132, and the valves (not illustrated) selectively supply cold water and hot water to the filter 120 as well as the cold water module 150 and hot water module 160, and the water take-out module 200.

The water take-out module mounting part 133 is formed at the upper end of the filter receiving part 132. The water take-out module mounting part 133 has a structure in which the water take-out module 200 can be inserted and fixed by forming a mounting groove 133a concave from top to bottom at the top. In this case, the water take-out module mounting part 133 may be formed to have a curvature corresponding to the curvature of the front cover 111 covering the front of the water take-out module mounting part 133. An upper portion of the filter bracket 130 may be shielded by a top cover 114.

A compressor 141 and a condenser 142 are provided on the upper surface of the base 113. In addition, a cooling fan 143 is provided between the compressor 141 and the condenser 142 and thus configured to allow cooling of the compressor 141 and the condenser 142. The compressor 141 may be an inverter type compressor capable of adjusting the cooling capacity by varying the frequency. Accordingly, the cooling of the purified water can be efficiently performed, thereby reducing power consumption.

In addition, the condenser 142 may be located at the rear of the base 113 and may be located at a position corresponding to the discharge port 112a formed in the rear cover 112. The condenser 142 may be formed by bending a flat tube type refrigerant pipe a plurality of times in order to efficiently use space and improve heat exchange efficiency at the same time and is configured to be received in the condenser bracket 144.

The condenser bracket 144 includes a condenser mounting part 145 to which the condenser 142 is fixed, and a cold water module mounting part 146 to which a cold water module 150 for making cold water can be mounted. The condenser mounting part 145 forms a space having a shape corresponding to the overall shape of the condenser 142 to receive the condenser 142. In addition, the condenser mounting part 145 is formed such that portions facing the cooling fan 143 and the discharge port 112a are opened, respectively, so that the condenser 142 can be effectively cooled.

In addition, the cold water module mounting part 146 is formed above the condenser bracket 144, that is, above the condenser mounting part 145. The lower end portion of the cold water module 150 is inserted into the cold water module mounting part 146, and thus the cold water module mounting part 146 fixes the cold water module 150.

The cold water module 150 is for making cold water by cooling the purified water and includes a cooling tank, and the cooling tank is filled with the cooling water for heat exchange with the inflow purified water. In addition, an evaporator for cooling the cooling water is received in the cooling tank, and a cooling flow path 151 is formed so that purified water passing through the filter 120 can pass through the inside of the cooling water module. Accordingly, the purified water may be cooled while circulating inside the cold water module 150 along the cooling flow path 151.

A support plate 135 extending toward the cold water module 150 is further provided on one side of the filter bracket 130. The support plate 135 is provided above the compressor 141 and extends from the filter bracket 130 to the condenser bracket 144 to provide a space in which the heating and control modules 160 and 170 are mounted.

The heating and control modules 160 and 170 may include a hot water module 160 for making hot water and a control assembly 170 for controlling overall driving of the water purifier 10. The hot water module 160 and the control assembly 170 may be coupled to each other to form a state of a single module and may be mounted on the support plate 135 in a coupled state.

The hot water module 160 is for heating purified water and may heat purified water using various well-known methods including an induction heating (IH) method. The hot water module 160 can heat water immediately and at a high speed when hot water is taken out, and hot water of a desired temperature can be taken out according to a user's manipulation.

The control assembly 170 is for controlling the operation of the water purifier 10 and can be configured to control the compressor 141, the cooling fan 143, various valves and sensors, the hot water module 160, and the like. The control assembly 170 may be modularly configured by a combination of PCBs divided into a plurality of parts for each function. In addition, in the structure in which the water purifier 10 takes out only cold water and purified water, the hot water module 160 and a PCB for controlling the same may be omitted, and at least one PCB may be omitted in this way.

Meanwhile, the purified water taken out from the filter 120 of the water purifier 10 passes through several flow paths, valves, and the like until taken out to the water taken out nozzle 210 or the drain port. In this case, in a case where the water purifier is used for a long time, foreign substances contained in the water may be caught in the flow paths, the valves, and the like, and microorganisms or the like may be propagated therein.

Therefore, it is necessary to periodically sterilize the flow paths, the valves, and the like. In the present disclosure, in addition to the hot water module 160 provided for generating hot water, a separate sterilization module may generate hot water and use the generated hot water to sterilize the flow paths and the valves.

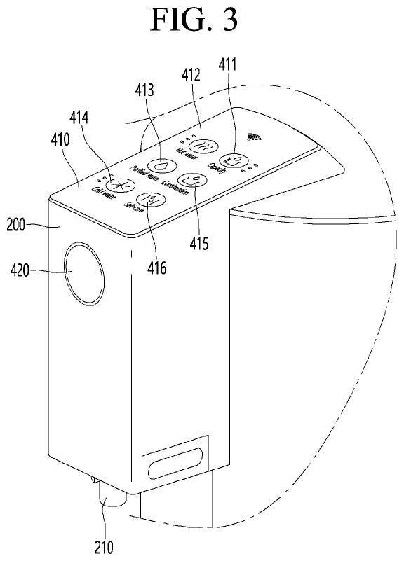

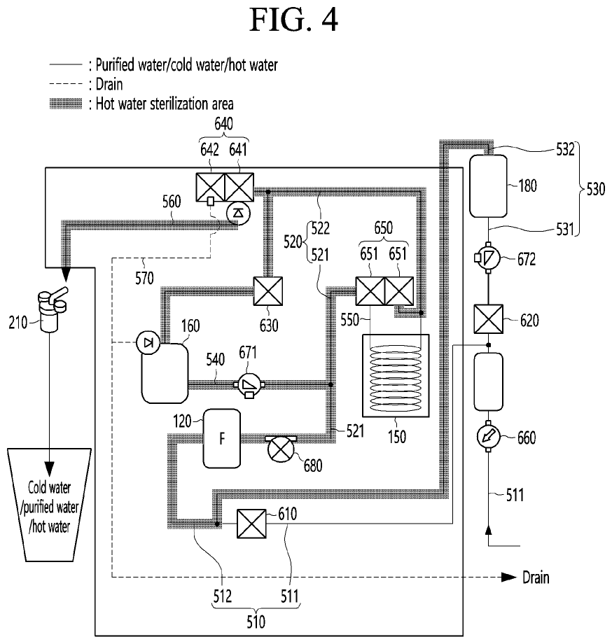

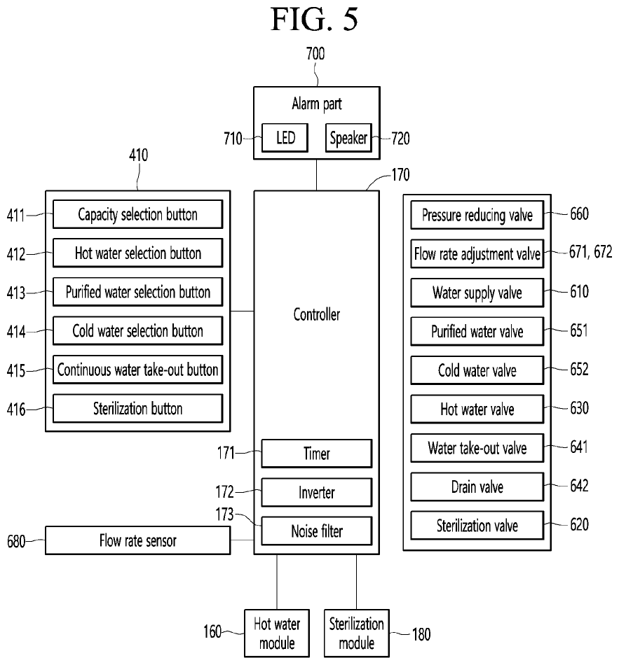

FIG. 3 is a perspective view illustrating a water take-out module, which is a component of the present disclosure, FIG. 4 is a view illustrating a flow path and a valve in the water purifier of the present disclosure, and FIG. 5 is a block diagram illustrating a water purifier according to an embodiment of the present disclosure. Referring to FIGS. 3 to 5, the water purifier according to the present disclosure includes a water supply flow path (also referred to as a first flow path or liquid supply flow path) 510 for supplying water supplied from a water supply source to the filter 120, and a water supply valve (or first valve) 610 which is provided on the water supply flow path 510 to regulate the flow of water passing through the water supply flow path 510.

In addition, the water purifier according to the present disclosure includes a purified water flow path (also referred to as a second flow path or a purified liquid flow path) 520 for guiding the purified water passing through the filter 120 toward the water take-out nozzle 210, a hot water flow path (or hot liquid flow path) 540 having one side branched from the purified water flow path 520 and the other side connected to a side of the water take-out nozzle 210, and a hot water module (or first heater) 160 which is provided on the hot water flow path 540 to heat the purified water passing through the hot water flow path 540.

In addition, the water purifier according to the present disclosure may include a sterilization flow path (or third flow path) 530 having one side branched from the water supply flow path 510 and the other side connected to a side of the filter 120, a sterilization valve (or second valve) 620 which is provided on the sterilization flow path 530 to regulate the flow of water passing through the sterilization flow path 530, and a sterilization module (or second heater) 180 which is provided on the sterilization flow path 530 to heat the water passing through the sterilization flow path 530. The sterilization module 180 may include a heating means for heating water passing through the sterilization flow path 530. For example, the sterilization module 180 may heat the water passing through the sterilization flow path 530 in an induction heating method. In addition, the sterilization flow path 530 supplies the water heated by the sterilization module 180 to the water supply flow path 510.

The hot water module 160 may include a heating tank, and a heater may be provided in the heating tank. For example, the hot water module 160 may heat the water passing through the hot water flow path in an induction heating method.

The water purifier 10 as described above may purify water supplied from an external water supply source and then discharge the purified water to the outside, or heat the purified water with hot water and then discharge the purified water to the outside. To this end, the water purifier 10 may be connected to an external water supply source by a water supply flow path 510 to receive water.

In addition, the water supply flow path 510 may be provided with a water supply valve 610 that regulates the flow of water supplied from the water supply source to the filter 120. For example, when the water supply valve 610 is opened, water is supplied from the water supply source to the filter 120, and when the water supply valve 610 is closed, the flow of water flowing from the water supply source to the filter 120 may be blocked.

In addition, a pressure reducing valve 660 for adjusting the water pressure of raw water flowing toward the filter may be installed in the water supply flow path 510. As described above, the water supplied from the water supply source through the water supply flow path 510 passes through the pressure reducing valve 660 and the water supply valve 610 sequentially, and then passes through the filter 120 and is purified into purified water.

In this case, one or more filters 120 may be provided, and in a case where a plurality of filters are provided, the filter 120 may be configured to combine various types of filters. For example, the filter 120 may be provided in three pieces and may include a pre-carbon filter and a post-carbon filter, and a membrane filter or a hollow fiber membrane filter disposed between the pre-carbon filter and the post-carbon filter. Of course, the number and type of the filters are not limited, but it is preferable that different types of functional filters are applied for the number that can be received in the water purifier 10 and for efficient water purification.

For reference, at least one filter may be separated from the water purifier in the process of hot water sterilization, which will be described below. When the filter is separated from the water purifier as described above, it is possible to prevent the filter from being damaged during the hot water sterilization process. In addition, when the filter is removed, it is advantageous to secure the flow rate, so that hot water sterilization can be performed more reliably and quickly.

The purified water which is purified while passing through the filter 120 is discharged to the outside of the water purifier 10. In this case, purified water may be discharged to the outside of the water purifier 10 through the water take-out nozzle 210. For example, purified water that has passed through the filter 120 may be supplied to the water take-out nozzle 210 as a state of purified water while flowing through the purified water flow path 520.

As another example, the purified water passing through the filter 120 can be branched from the purified water flow path 520 to the hot water flow path 540, heated in the hot water module 160, and then supplied to the water take-out nozzle 210 in a state of hot water. The purified water flow path 520 is provided with a water purification valve (or liquid purification valve) 651 to regulate the flow of purified water passing through the purified water flow path 520.

Meanwhile, the hot water flow path 540 is branched from the purified water flow path 520 and transfers the purified water passing through the filter 120 toward the water take-out nozzle 210, wherein the purified water is heated at the hot water module 160 provided on the hot water flow path 540 and then the heated hot water is transferred toward the water take-out nozzle 210. In addition, a flow rate adjustment valve 671 is provided in the hot water flow path 540 to adjust the amount of purified water supplied to the hot water flow path 540. In addition, the hot water flow path 540 between the hot water module 160 and the water take-out nozzle 210 may include a hot water valve 630 for regulating the flow of hot water.

In addition, in the present disclosure, the sterilization module 180 is provided to sterilize various flow paths (pipes), valves, tanks, water take-out nozzles, and the like inside the water purifier. The sterilization module 180 is installed on the sterilization flow path 530.

The sterilization flow path 530 is branched from the water supply flow path 510 into which raw water flows and then is merged into the water supply flow path 510. As described above, the hot water heated in the sterilization module 180 flows into the water supply flow path 510 and then passes through the filter 120, sterilizes at least one of the purified water flow path 520, the hot water flow path 540, and the cold water flow path 550 while flowing at least one of the purified water flow path 520, the hot water flow path 540, and the cold water flow path 550.

For example, the sterilization flow path 530 and the sterilization module 180 may be disposed inside the housing 110. In addition, the sterilization flow path 530 and the sterilization module 180 may be used in a state of being installed in the water purifier.

As another example, the sterilization flow path 530 and the sterilization module 180 may be disposed outside the housing 110. In addition, the sterilization flow path 530 and the sterilization module 180 may be used in a state of being installed in the water purifier or may be used by being installed after being separated as needed.

Referring back to FIG. 4, the water supply flow path 510 may include a first water supply flow path (or first liquid supply flow path) 511 connecting the water supply source and the water supply valve 610, and a second water supply flow path (or second liquid supply flow path) 512 connecting the water supply valve 610 and the filter 120. In addition, the sterilization flow path 530 may be branched from the first water supply flow path 511 and then be merged into the second water supply flow path 512.

Accordingly, the hot water generated by the sterilization module 180 may sterilize the flow path after the water supply valve 610 based on the flow direction of the water. For reference, in the hot water sterilization mode, the water supply valve 610 is in a state of being closed, and the sterilization valve 620 is opened. Accordingly, the raw water flows through the first water supply flow path 511, the sterilization flow path 530, and the second water supply flow path 512.

On the other hand, in the normal mode, that is, in a mode in which purified water, cold water, and hot water are supplied to the water take-out nozzle 210, the water supply valve 610 is opened and the sterilization valve 620 is maintained in a closed state. Accordingly, the raw water flows through the first water supply flow path 511 and the second water supply flow path 512.

A pressure reducing valve 660 for adjusting the water pressure of the incoming raw water may be installed in the first water supply flow path 511. For example, the pressure reducing valve 600 may be installed before a branch point of the sterilization flow path 530 based on the flow direction of the raw water.

In addition, in the sterilization flow path 530, a flow adjustment valve 672 may be installed between the sterilization valve 620 and the sterilization module 180. The sterilization flow path 530 may include a first sterilization flow path 531 having one side connected to the first water supply flow path 511 and the other side connected to the inlet of the sterilization module 180, and a second sterilization flow path 532 having one side connected to the outlet of the sterilization module 180 and the other side connected to the purified water flow path 520. The second sterilization flow path 532 may be connected to a first water purification flow path (or first liquid purification flow path) 521 to be described below.

Referring back to FIG. 4, a water purification valve 651 for regulating the flow of water is installed in the purified water flow path 520, and the purified water flow path 520 may include a first purified water flow path 521 that connects the filter 120 and the water purification valve 651 and a second purified water flow path (or second liquid purification flow path) 522 that connects the purified water valve 651 and the water take- out valve (also referred to as a fourth valve or a liquid take-out valve) 641 installed at the side of the water take-out nozzle 210.

In addition, a flow rate sensor 680 may be installed in the first purified water flow path 521. In detail, the flow sensor 680 may be installed between the filter 120 and the branch point of the hot water flow path 540. In addition, the hot water flow path 540 may branch off from the first purified water flow path 521 and then merge at the second purified water flow path 522.

Alternatively, the hot water flow path 540 may have one side branched from the first purified water flow path 521 and the other side connected to the water take-out valve 641. Alternatively, the hot water flow path 540 may have one side branched from the first purified water flow path 521 and the other side connected to the water take-out flow path (or liquid take-out flow path) 560. In addition, a flow rate adjustment valve 671 for adjusting the flow rate of water flowing into the hot water module 160 may be installed in the hot water flow path 540.

Referring back to FIG. 4, the water purifier according to the present disclosure further includes a water take-out flow path 560 having one side connected to the water take-out nozzle 210 and the other side connected to the second water purification flow path 520, and a water take-out valve 641 for regulating the flow of water flowing to the water take-out nozzle may be installed in the water take-out flow path 560.

In addition, a drain valve (or third valve) 642 is installed in the water take- out valve 641 together therewith, and the water discharged from the drain valve 642 can be discharged to the outside of the housing 110 through a separate drain flow path (or fourth flow path) 570. In addition, steam generated in the hot water tank of the hot water module 160 may be discharged to the outside through the drain flow path 570.

The water take-out valve 641 and the drain valve 642 may be formed separately or integrally. The water take-out valve 641 and the drain valve 642 may be formed as a three way valve 640 having one inlet and two outlets. The three-way valve 640 may transfer the water supplied from the purified water flow path 520 to the water take-out flow path 560 or to the drain flow path 570.

In addition, at least a portion of the hot water generated by the sterilization module 180 and flowing into the water take-out valve 641 or drain valve 642 is discharged to the water take-out nozzle 210, and the remaining part thereof can be discharged to the drain flow path 570. If, after being generated in the sterilization module 180, all of the high-temperature hot water that has been sterilized in the flow path is discharged to the water take-out nozzle 210, 3 L or more of hot water is continuously taken out to the water take-out nozzle 210 and thus it is disadvantageous to the safety of the user, and there is a inconvenience of having to process the discharged hot water.

In order to prevent this, the amount of hot water required for hot water sterilization of the water take-out flow path 560 and the water take-out nozzle 210 is supplied to the water take-out flow path 560 and discharged to the water take-out nozzle 210, and the remaining hot water is discharged through the drain flow path 570 to the outside. For example, about 200 ml of hot water may be discharged to the water take-out flow path 560 and the water take-out nozzle 210, and the remaining hot water may be discharged to the outside through the drain flow path 570.

Referring back to FIG. 4, the water purifier may further include a cold water flow path (or cold liquid flow path) 550 having one side branched from the purified water flow path 520 and the other side connected to a side of the water take-out nozzle 210, and a cold water module (or cooler) 150 provided on the cold water flow path 550 to cool the water passing through the cold water flow path 550. The cold water flow path 550 may branch from the first purified water flow path 521 and then be merged into the second purified water flow path 522.

Meanwhile, the cold water flow path 550 transfers the purified water that has passed through the filter 120 toward the water take-out nozzle 210 and after cooling the purified water in the cold water module 150 provided on the cold water flow path 550, transfers the purified water toward the water take-out nozzle 210.

In addition, the water purifier may further include a cold water valve (or cold liquid valve) 652 provided on the cold water flow path 550 or the purified water flow path 520 to regulate the flow of water flowing into the cold water flow path 550. The water purification valve 651 and the cold water valve 652 may be formed separately or integrally.

The water purification valve 651 and the cold water valve 652 may be formed as a three way valve 650 having one inlet and two outlets. The three-way valve 650 may transmit the water supplied from the first purified water flow path 521 to the second purified water flow path 522 or to the cold water flow path 550.

Referring back to FIG. 4, the hot water generated by the sterilization module passes through the filter 120 and sterilizes the various flow paths and valves while flowing through the purified water flow path 520, the hot water flow path 540, and the cold water flow path 550, and some of the hot water may be discharged to the water take-out nozzle 210 through the water take-out flow path 560, and the rest may be discharged to the outside through the drain flow path 570.

In detail, the water discharged to the drain flow path 570 may be discharged to the outside of the water purifier 10 through a separate outlet formed at the rear or side of the water purifier 10 instead of the water take-out nozzle 210. In this case, the drain flow path 570 may extend to the outside of the water purifier 10, and the end of the drain flow path 570 may be connected to a sink, a sewer, or the like.

In addition, the water purifier 10 of the present disclosure may further include a steam flow path and a safety valve for discharging steam generated when hot water is heated in the hot water tank of the hot water module 160. Accordingly, it is possible to prevent the pressure inside the hot water tank from being excessively increased by the steam. The safety valve is configured to be opened at a predetermined pressure and may have various structures within a range in which the steam inside the hot water tank can be smoothly discharged.

Meanwhile, the vapor flow path may also be connected to the drain flow path 570. Accordingly, the steam discharged from the hot water tank may also be discharged to the outside of the water purifier 10 through the drain flow path 570. Hereinafter, an example of the hot water sterilization process of the water purifier 10 configured as described above will be described.

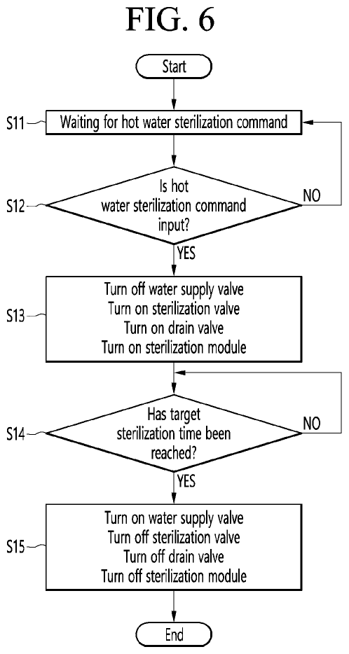

FIG. 6 is a flowchart illustrating a method for controlling a water purifier according to an embodiment of the present disclosure. Referring to FIGS. 4 to 6, the water supply valve 610 is closed and the sterilization valve 620 is opened for hot water sterilization and hot water washing. Then, the sterilization module 180 is turned on.

In addition, the water purification valve 651, the cold water valve 652, and the hot water valve 630 are opened, and the hot water module 160 and the cold water module 150 do not operate. In addition, the raw water flowing into the first water supply flow path 511 flows into the first sterilization flow path 531.

Then, by the sterilization module 180 mounted on the sterilization flow path 530, the raw water is heated with hot water. The hot water heated in the sterilization module 180 is supplied to the second water supply flow path 512 through the second sterilization flow path 532, and the hot water supplied to the second water supply flow path 512 passes through the filter 120 and then is supplied to the purified water flow path 520.

At this time, in a case where the filter 120 is in a separated state, the hot water supplied to the second water supply flow path 512 flows directly into the first purified water flow path 521. Then, the hot water flowing into the first purified water flow path 521 flows to the water take-out valve 641 through the purified water valve 651 and the second purified water flow path 522.

In addition, the hot water flowing into the first purified water flow path 521 may be branched into the hot water flow path 540, pass through the hot water flow path 540 and the hot water module, and then flow to the water take-out valve 641. In addition, the hot water flowing into the first purified water flow path 521 is branched into the cold water flow path 550, passes through the cold water flow path 550 and the cold water module, and then passes through the second purified water flow path 522, and flows into the water take-out valve 641. In a state where the water take-out valve 641 is opened, at least a portion of the hot water flowing into the water take-out valve 641 is supplied to the water take-out flow path 560 and discharged to the outside through the water take-out nozzle 210.

Then, the water take-out valve 641 is closed, and the drain valve 642 is opened. As the drain valve 642 is opened, the hot water flowing into the water take-out valve 641 is supplied to the drain flow path 570 and discharged to the outside through the drain flow path 570.

Accordingly, Hot water sterilization and hot water washing of the purified water flow path 520, the hot water flow path 540, the hot water module, the cold water flow path 550, the cold water module, the water take-out flow path 560, the drain flow path 570, and the water take-out nozzle 210 may be performed by the hot water generated by the sterilization module 180. In this case, hot water sterilization and hot water washing of the purified water flow path 520, the hot water flow path 540, and the cold water flow path 550 may be performed simultaneously or separately.

Referring back to FIG. 5, the water purifier of the present disclosure may include a manipulation part (or input device) 410 which receives hot water sterilization and hot water washing commands from the user and a controller 170 which controls to open and close the various valves when the hot water sterilization and hot water washing commands are input to the manipulation part 410. For example, when the hot water sterilization and hot water washing commands are input to the manipulation part 410, the controller 170 may turn on the sterilization valve 620 and the sterilization module 180 and may turn off the water supply valve 610, the hot water module 160, and the cold water module 150.

Here, the controller 170 may refer to the above-described control assembly 170 or may refer to a controller provided separately from the control assembly 170. In this embodiment, the manipulation part 410 may be provided on the upper surface of the water take-out module 200. In order for the manipulation part 410 to be provided on the upper surface of the water take-out module 200 as described above, a receiving space in which the manipulation part 410 is received may be formed on the upper surface of the housing 220.

According to the present disclosure, the manipulation part 410 is provided on the upper surface of the water take-out module 200, so that a tall adult user can easily adjust the overall operation of the water purifier 10. On the other hand, in a case of a small child user, the manipulation part 410 provided on the upper surface of the water take-out module 200 cannot be recognized, and even if it is recognized, it cannot be easily manipulated, and thus it is possible to prevent safety accidents such as burns on the hand while hot water flows out by pressing manipulation part 410 at random.

As an example, the manipulation part 410 is provided with a touch panel and may include a capacity button 411 for selecting the water take-out capacity, a hot water button 412 for selecting hot water and further selecting the temperature of the hot water to be taken out, a water purification button 413 for selecting purified water, a cold water button 414 for selecting cold water, a continuous button 415 for selecting continuous water take-out, and a sterilization button 416 for inputting hot water sterilization and hot water washing commands.

In addition, the manipulation part 410 may be formed to be inclined downward from the rear to the front. Accordingly, a user located in front of the water purifier may manipulate the manipulation part 410 in a state where readability is secured.

In addition, the controller 170 may include an inverter 172. The inverter 172 may adjust the amount of heating by controlling the amount of current applied to the hot water module 160. In other words, the output of the hot water module 160 may be adjusted by the inverter 172. In a case where the amount of heating is adjusted in this way, the water may be heated to a temperature desired by the user.

In addition, the controller 170 may further include a noise filter 173. The noise filter 173 serves to remove noise from a signal including noise generated by a magnetic field generated by a current applied to the hot water module 160.

The noise filter 520 may control noise in control signals output from the controller 170 and applied to various valves or the like. In addition, the controller 170 may include a timer 171 for measuring the sterilization and washing time. According to the proposed disclosure, it is possible to sterilize various flow paths and valves inside the water purifier by circulating hot water heated in a separate sterilization module.

According to the present disclosure, since hot water sterilization proceeds while continuous water take-out proceeds, there is an effect that while sterilization of the flow path and the valve proceed by the flow rate, at the same time, the removal of foreign substances can be made. According to the present disclosure, it is possible to wash the entire flow paths and the valves inside the water purifier from the water supply flow path connected to the water supply source to the water take-out flow path connected to the water take-out nozzle or outlet.

According to the present disclosure, there is an effect that the washing of the flow path and the valve inside the water purifier can be automatically performed only by pressing a button at a time desired by the user. According to the present disclosure, there is a possible effect of hot water sterilization and hot water washing up to the filter installed at the entrance of the water purifier flow path.

According to the present disclosure, part of the hot water generated while performing the hot water sterilization and the hot water washing in the entire flow path included in the water purifier can be discharged to the water take-out nozzle, and the rest can be drained to the rear end of the water purifier, so that there is an effect that it is possible to prevent safety accidents such as burns that may occur while a large amount of hot water is discharged through the water take-out nozzle, and that it is possible to prevent the user from having to process a large amount of hot water.

An aspect of the present disclosure is to provide a water purifier capable of sterilizing various flow paths and valves inside the water purifier by circulating hot water heated in a separate sterilization module. An aspect of the present disclosure is to provide a water purifier capable of simultaneously removing foreign substances while sterilizing flow paths and valves by flow rate because hot water sterilization proceeds while continuous water take-out proceeds.

In addition, another aspect of the present disclosure is to provide a water purifier capable of washing the entire flow path and valve inside the water purifier from a water supply flow path connected to a water supply source to a water take-out nozzle or water take-out flow path. An aspect of the present disclosure is to provide a water purifier capable of automatically washing flow paths and valves inside the water purifier only by pressing a button at a time desired by a user.

A water purifier of the present disclosure for achieving the above aspects may include a housing forming a storage space, a filter provided inside the housing to purify water flowing thereinto, a water supply flow path which supplies water supplied from a water supply source outside the housing to the filter, a water supply valve provided on the water supply flow path to regulate the flow of water passing through the water supply flow path, a water take-out nozzle provided on the outside of the housing and through which the water passing through the filter is taken out, a purified water flow path configured to guide the purified water passing through the filter toward the water take-out nozzle, a hot water flow path having one side branched from the purified water flow path and the other side connected to a side of the water take-out nozzle, a hot water module provided on the hot water flow path to heat the purified water passing through the hot water flow path.

In addition, the water purifier may include a sterilization flow path having one side branched from the water supply flow path and the other side connected to a side of the filter, a sterilization valve provided on the sterilization flow path to regulate the flow of water passing through the sterilization flow path, and a sterilization module provided on the sterilization flow path to heat water passing through the sterilization flow path, in which the sterilization flow path may supply water heated in the sterilization module to the water supply flow path.

The water supply flow path may include a first water supply flow path connecting the water supply source and the water supply valve, and a second water supply flow path connecting the water supply valve and the filter. The sterilization flow path may be branched from the first water supply flow path and then be merged into the second water supply flow path.

In the first water supply flow path, a pressure reducing valve configured to adjust the water pressure of raw water flowing into the first water supply flow path may be installed. In the sterilization flow path, a flow rate adjustment valve may be installed between the sterilization valve and the sterilization module.

A water purification valve configured to regulate the flow of water may be installed in the purified water flow path, and the purified water flow path may include a first purified water flow path connecting the filter and the water purification valve, and a second purified water flow path connecting the water purification valve and a water take-out valve installed on the side of the water take-out nozzle.

The hot water flow path may be branched from the first purified water flow path and then merge at the second purified water flow path. A flow rate adjustment valve configured to adjust the flow rate of water flowing into the hot water module may be installed in the hot water flow path.

The water purifier of may further include a water take-out flow path having one side connected to the water take-out nozzle and the other side connected to the second purified water flow path, and a water take-out valve configured to regulate the flow of water flowing into the water take-out nozzle may be installed in the water take-out flow path.

A drain valve may be installed in the water take-out valve together therewith, and the water discharged from the drain valve may be discharged to the outside of the housing through a drain flow path. At least a portion of the hot water generated by the sterilization module and flowing into the water take-out valve or the drain valve may be discharged to the water take-out nozzle, and the remaining portion thereof may be discharged to the drain flow path.

The water purifier may further include a cold water flow path having one side branched from the purified water flow path and the other side connected to a side of the water take-out nozzle, and a cold water module provided on the cold water flow path to cool the water passing through the cold water flow path. The water purifier may further include a cold water valve provided on the cold water flow path to regulate the flow of water flowing through the cold water flow path. The cold water valve and the water purification valve may be integrally formed. The hot water generated by the sterilization module may sterilize a hot water module, a cold water module, and various flow paths and valves while flowing the purified water flow path, the hot water flow path, and the cold water flow path through the filter.

The water purifier of claim may include a manipulation part configured to receive a sterilization command from the user, and a controller which turns on the sterilization valve and the sterilization module and turns off the water supply valve, the hot water module, and the cold water module when a sterilization command is input to the manipulation part.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A liquid purifier, comprising:
a housing;
a filter provided inside the housing to purify liquid flowing thereinto;
a first liquid supply flow path receiving liquid from a source outside the housing, and a second liquid supply flow path through which liquid flows between the first liquid supply flow path and the filter;
a first valve provided between the first liquid supply flow path and the second liquid supply flow path to regulate a flow of liquid flowing from the first liquid supply flow path to the second liquid supply flow path;
a nozzle through which liquid is dispensed from the liquid purifier;
a purified liquid flow path configured to guide liquid from the filter toward the nozzle;
a hot liquid flow path having a first end fluidly connected to the purified liquid flow path and second end fluidly connected to a side of the nozzle;
a first heater provided on the hot liquid flow path to heat liquid passing through the hot liquid flow path;
a sterilization flow path having a first end fluidly connected to the first liquid supply flow path and a second end fluidly connected to the second liquid supply flow path;
a second valve provided on the sterilization flow path to regulate the flow of liquid passing through the sterilization flow path;
a second heater provided on the sterilization flow path to heat liquid passing through the sterilization flow path; and
a controller configured to control the first valve to be opened and the second valve to be closed in a liquid purification mode and configured to control the second valve to be opened and the first valve to be closed in a sterilization mode.

2. The liquid purifier of claim 1, further comprising:
a pressure reducing valve that provided in the first liquid supply flow path and configured to adjust a pressure of liquid flowing into the first liquid supply flow path.

3. The liquid purifier of claim 1, further comprising:
a flow rate adjustment valve that is provided in the sterilization flow path and is installed between the second valve and the second heater.

4. The liquid purifier of claim 1, further comprising:
a liquid purification valve that is configured to regulate the flow of liquid and is installed in the purified liquid flow path, and
wherein the purified liquid flow path includes a first purified liquid flow path connecting the filter and the liquid purification valve, and a second purified liquid flow path connecting the liquid purification valve and a liquid take-out valve regulating a flow of liquid to the nozzle.

5. The liquid purifier of claim 4,
wherein the hot liquid flow path includes a first end that is fluidly connected to the first purified liquid flow path and a second end that is fluidly connected to the second purified liquid flow path.

6. The liquid purifier of claim 5, further comprising:
a flow rate adjustment valve configured to adjust the flow rate of liquid flowing into the first heater and installed in the hot liquid flow path.

7. The liquid purifier of claim 5, further comprising:
a liquid take-out flow path having a first end fluidly connected to the nozzle and a second end fluidly connected to the second purified liquid flow path; and
a liquid take-out valve configured to regulate a flow of liquid to the nozzle and installed in the liquid take-out flow path.

8. The liquid purifier of claim 7, further comprising:
a drain valve that is coupled to the liquid take-out valve,
wherein liquid discharged from the drain valve is discharged outside of the housing through a drain flow path.

9. The liquid purifier of claim 8,
wherein a first portion of the hot liquid generated by the second heater is discharged through the liquid take-out valve to the nozzle, and a second portion thereof is discharged through the drain valve to the drain flow path.

10. The liquid purifier of claim 4, further comprising:
a cold liquid flow path having a first end fluidly connected to the purified liquid flow path and a second end fluidly connected to the nozzle; and
a cooler provided on the cold liquid flow path to cool liquid passing through the cold liquid flow path.

11. The liquid purifier of claim 10, further comprising:
a cold liquid valve provided on the cold liquid flow path to regulate a flow of liquid flowing through the cold liquid flow path.

12. The liquid purifier of claim 11,
wherein the cold liquid valve and the liquid purification valve are integrally formed.

13. The liquid purifier of claim 10,
wherein hot liquid generated by the second heater sterilizes at least one of the first heater, the cooler, and one or more flow paths and valves while flowing along the purified liquid flow path, the hot liquid flow path, and the cold liquid flow path through the filter during the sterilization mode.

14. The liquid purifier of claim 10, further comprising:
an input device configured to receive a sterilization command,
wherein when the sterilization command is received by the input device, the controller opens the second valve, turns on the second heater, closes the first valve, and turns off the first heater and the cooler.

15. A liquid purifier comprising:
a housing;
a filter provided inside the housing to purify liquid;
a first flow path providing liquid from an external source to the filter;
a first valve provided on the first flow path;
a nozzle;
a second flow path configured to guide liquid between the filter and the nozzle;
a first heater provided to selectively heat liquid in the second flow path;
a third flow path having a first end to receive liquid from the external source and a second end fluidly connected to the first flow path downstream of the first valve and upstream of the first heater;
a second valve provided on the third flow path;
a second heater provided on the third flow path to heat liquid in the third flow path; and
a controller configured to alternatively control the first valve to be opened and the second valve to be closed such that liquid bypasses the second heater and to control the second valve to be opened and the first valve to be closed such that heated liquid from the second heater is provided to at least one of the first flow path, the second flow path, the first heater, or the filter.

16. The liquid purifier of claim 15, further comprising:
a cooler provided to selectively cool liquid in the second flow path, wherein heated liquid from the second heater is provided to sterilize the cooler when the second valve is opened and the first valve is closed.

17. The liquid purifier of claim 15, further comprising:
a third valve provided on the second flow path and directing at least a first portion of liquid in the second flow path along a fourth flow path away from the nozzle when the second valve is opened and the first valve is closed.

18. The liquid purifier of claim 17, further comprising:
a fourth valve provided on the second flow path and directing at least a second portion of liquid in the second flow path toward from the nozzle when the first valve is open and the second valve is closed, the third valve and the fourth valve being integrally formed.

19. The liquid purifier of claim 17, further comprising:
an input device configured to receive a sterilization command,
wherein, when the input device receives the sterilization command, the controller opens the second valve and the third valve, turns on the second heater, closes the first valve, and turns off the first heater.

20. The liquid purifier of claim 19, wherein, after a prescribed time following the user inputting the sterilization command to the input device, the controller closes the second valve and the third valve, turns off the second heater, and opens the first valve.
